(19) United States
(12) Patent Application Publication
(10) Pub. No.: US 2018/0267464 A1
(43) Pub. Date: Sep. 20, 2018

(54) HOLOGRAM RECORDING AND REPRODUCING APPARATUS AND HOLOGRAM RECORDING AND REPRODUCING METHOD

(71) Applicant: Hitachi-LG Data Storage, Inc., Tokyo (JP)

(72) Inventor: Shuichi MINAMIGUCHI, Tokyo (JP)

(21) Appl. No.: 15/556,097

(22) PCT Filed: Mar. 7, 2016
(86) PCT No.: PCT/JP2016/056913

§ 371 Date: Sep. 6, 2017

(30) Foreign Application Priority Data
Mar. 12, 2015 (JP) 2015-049854

(51) Int. Cl. G03H 1/04; G03H 1/26; G11B 7/0065

(52) U.S. Cl. CPC G03H 1/04; G11B 7/0065; G03H 1/26

(57) ABSTRACT

In relation to recording and reproducing of a hologram, consideration has not thus far been given to crosstalk among adjacent pages Information is recorded by writing onto a holographic medium, an interference pattern formed by signal light and reference light, and the recorded information is reproduced by the reference light being projected on the interference pattern. According to the method, when angle multiplexing recordings in units of pages is carried out in a holographic medium by changing the angle of incidence of reference light, and if a stack is defined as a unit of angle multiplexing recording in the same location in the holographic medium and a book is defined as a set of multiple stacks with shifted recording positions, for adjacent stacks therein, recording is carried out by allotting, between the reference light angles for one of the stacks, reference light angles for the stacks adjacent thereto.

### TECHNICAL FIELD

The present invention relates to a hologram recording and reproducing apparatus for recording and reproducing information on and from a hologram medium with the use of holography, and a hologram recording and reproducing method used for the apparatus.

### BACKGROUND ART

In order to realize high-density optical storage, high-density techniques using a new system are required, which are different from a high-density technique with a shortened wavelength of a laser and an increased NA of an objective lens used for the existing Blu-ray (registered trademark) Disc and the like. Among the high-density techniques, attention is attracted to a hologram recording technology for recording digital information with the use of holography.

The hologram recording technique is directed to a technique in which a signal light having information of page data two-dimensionally modulated by a spatial light modulator is superimposed on a reference light inside a recording medium, and a refractive index modulation is caused in the recording medium by an interference fringe pattern generated at that time, to thereby record the information on the recording medium. At the time of reproducing the information, when the recording medium is irradiated with the reference light used for recording, the hologram recorded on the recording medium acts like a diffraction grating to generate a diffracted light. The diffracted light including the recorded signal light and phase information is reproduced as the same light. The reproduced signal light is two-dimensionally and rapidly detected with the use of an imaging element. In this manner, the hologram recording technique makes it possible to record and reproduce two-dimensional information on an optical recording medium with one hologram.

Japanese Unexamined Patent Application Publication No. 2004-272268 (Patent Literature 1) is available as a background art related to the hologram recording technology. Patent Literature 1 discloses a multiplexing method and apparatus in which holograms are spatially multiplexed by partial spatial overlap between adjacent stacks of holograms.

### CITATION LIST

### Patent Literature

### Patent Literature 1: Japanese Unexamined Patent Application Publication No. 2004-272268

### SUMMARY OF INVENTION

### Solution to Problem

Patent Literature 1 fails to disclose how to allocate an angle of a page when recording the page while changing the angle in a stack and fails to consider a crosstalk with the adjacent pages. For that reason, the above technique may suffer from any problem, for example, when increasing the angular multiplexing number or decreasing a distance of adjacent holograms on the medium to further improve a recording density.

In order to solve the abovementioned problems, the present invention aims at providing a hologram recording and reproducing apparatus and a hologram recording and reproducing method which are capable of improving recording quality with reduced crosstalk from adjacent pages, and capable of performing recording with a high density.

### Solution to Problem

In order to solve the above problem, for example, the configurations defined in the claims are adopted. The present application includes a plurality of means for solving the above problem. For example, there is provided a hologram recording and reproducing method in which an interference fringe pattern is formed with irradiation of a signal light and a reference light and written on a hologram medium to record information, and the interference fringe pattern is irradiated with the reference pattern to reproduce the recorded information, in which in the case where angle multiplexing recording is performed on a hologram medium page by page with a change in an incident angle of the reference light, when an angle multiplexing recording unit at the same location on the hologram medium is assumed to be a stack and an aggregation of a plurality of the stacks whose recording positions are displaced from each other is assumed to be a book, a reference light angle of another stack is allocated into a reference light angle of one stack for recording in the stacks adjacent to each other.

### Advantageous Effects of Invention

According to the present invention, there can be provided a hologram recording and reproducing apparatus and a hologram recording and reproducing method which are capable of realizing recording quality with reduced crosstalk from adjacent pages, and capable of performing recording with a high density.

### BRIEF DESCRIPTION OF DRAWINGS

FIG. 1 A block diagram of a hologram recording and reproducing apparatus according to a first embodiment.

FIG. 2 A basic optical system configuration diagram of a pickup in the hologram recording and reproducing apparatus according to the first embodiment.

FIG. 3 Flowcharts of recording and reproducing operation of the hologram recording and reproducing apparatus according to the first embodiment.

FIG. 4 A conceptual diagram illustrating a state of recording for each stack according to the first embodiment.

FIG. 5 Conceptual diagrams illustrating a relationship of a position, a reference light angle, and a light density of each stack according to the first embodiment.

FIG. 6 A diagram illustrating a reproduced signal intensity to a reference light incident angle according to the first embodiment.

FIG. 7 Conceptual diagrams illustrating a relationship between the position and the reference light angle of each stack and each book according to the first embodiment.

FIG. 8 Conceptual diagrams illustrating a relationship between a position and a reference light angle of each stack according to a second embodiment.

FIG. 9 A conceptual diagram illustrating a relationship between the position and the reference light angle of each stack and each book according to the second embodiment.

FIG. 10 Conceptual diagrams illustrating a relationship between a position and a reference light angle of each stack and each book, and angle allocation of the reference light angle according to a third embodiment.

FIG. 11 Conceptual diagrams illustrating a relationship between a position and a reference light angle of each stack and each book when stack recording positions are set to be uniform or nonuniform according to a fourth embodiment.

FIG. 12 A conceptual diagram illustrating a relationship between a position and a reference light angle of each stack and each book according to a fifth embodiment.

FIG. 13 A conceptual diagram illustrating a state of recording for each stack as a premise of the present embodiment.

FIG. 14 Conceptual diagrams illustrating a relationship of a position, a reference light angle, and a light density of each stack as the premise of the present embodiment.

FIG. 15 A diagram illustrating a reproduced signal intensity to a reference light incident angle as the premise of the present embodiment.

FIG. 16 A conceptual diagram illustrating a relationship between the position and the reference light angle of each stack and each book as the premise of the present embodiment.

### DESCRIPTION OF EMBODIMENTS

Hereinafter, embodiments of the present invention will be described with reference to the drawings.

### First Embodiment

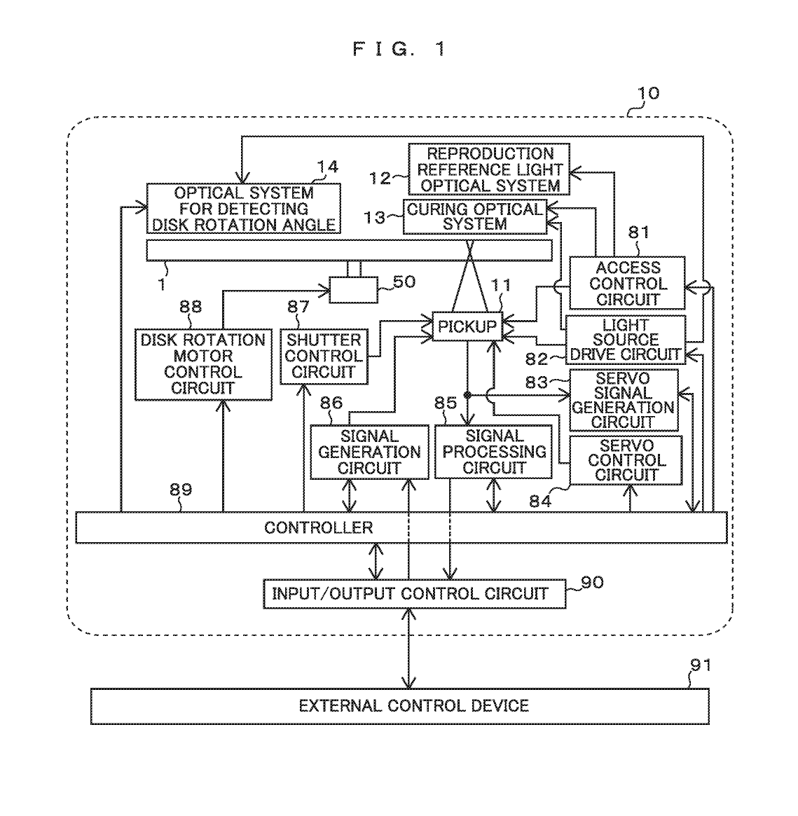

FIG. 1 is a block diagram showing a hologram recording and reproducing apparatus for recording and/or reproducing digital information with the use of holography according to the present embodiment. In FIG. 1, the hologram recording and reproducing apparatus 10 is connected to an external control apparatus 91 through an input/output control circuit 90. In the case of recording, the hologram recording and reproducing apparatus 10 receives an information signal to be recorded from the external control device 91 by the input/output control circuit 90. In the case of reproducing, the hologram recording and reproducing apparatus 10 transmits the reproduced information signal to the external control apparatus 91 through the input/output control circuit 90.

The hologram recording and reproducing apparatus 10 includes a pickup 11, a reproduction reference light optical system 12, a curing optical system 13, an optical system 14 for detecting a disc rotation angle, and a rotation motor 50. A hologram medium 1 is configured to be rotatable by a rotation motor 50.

The pickup 11 performs a function of emitting a reference light and a signal light to the hologram medium 1 and recording digital information on a recording medium with the use of the holography. At this time, an information signal to be recorded is transmitted by a controller 89 to a spatial light modulator in the pickup 11 through a signal generation circuit 86, and the signal light is modulated by the spatial light modulator.

In the case of reproducing the information recorded on the hologram medium 1, a light wave for causing the reference light emitted from the pickup 11 to be incident on the hologram medium in a direction opposite to the direction of recording is generated by the reproduction reference light optical system 12. The reproduced light reproduced by the reproduction reference light is detected by a photodetector which will be described later in the pickup 11, and the signal is reproduced by the signal processing circuit 85.

An irradiation time of the reference light and the signal light with which the hologram medium 1 is irradiated can be adjusted by controlling an opening and closing time of a shutter in the pickup 11 through a shutter control circuit 87 by the controller 89.

The curing optical system 13 performs a function of generating a light beam used for precuring and postcuring the hologram medium 1. The precuring is a previous step of irradiating the hologram medium 1 with a predetermined light beam in advance before irradiation of the reference light and the signal light at a desired position when information is recorded at the desired position in the hologram medium 1. The postcure is a post-process of irradiating the hologram medium 1 with a predetermined light beam for making the hologram medium 1 unrecordable at the desired position after having recorded the information at the desired position in the hologram medium 1.

The disc rotation angle detecting optical system 14 is used for detecting the rotation angle of the hologram medium 1. In the case of adjusting the hologram medium 1 to a predetermined rotation angle, a signal corresponding to the rotation angle is detected by the disc rotation angle detecting optical system 14, and the rotation angle of the hologram medium 1 can be controlled by the controller 89 through the disc rotation motor control circuit 88 with the use of the detected signal.

A predetermined light source drive current is supplied from the light source drive circuit 82 to light sources in the pickup 11, the curing optical system 13, and the disc rotation angle detection optical system 14, and each of the light sources can emit a light beam with a predetermined light amount.

Further, the pickup 11 and the curing optical system 13 are each provided with a mechanism capable of sliding each position in a radial direction of the hologram medium 1, and position control is performed through the access control circuit 81.

In the recording technique using a principle of angle multiplexing of the holography, a tolerance to the deviation of the reference light angle tends to be extremely small. Therefore, a mechanism for detecting the deviation amount of the reference light angle is provided in the pickup 11, a servo control signal is generated in the servo signal generation circuit 83, and a servo mechanism for correcting the deviation amount through a servo control circuit 84 is disposed in the hologram recording and reproducing apparatus 10, to thereby control the reference light angle with high accuracy.

The pickup 11, the curing optical system 13, and the disc rotation angle detecting optical system 14 may be simplified by combining several optical system configurations or all optical system configurations into one.

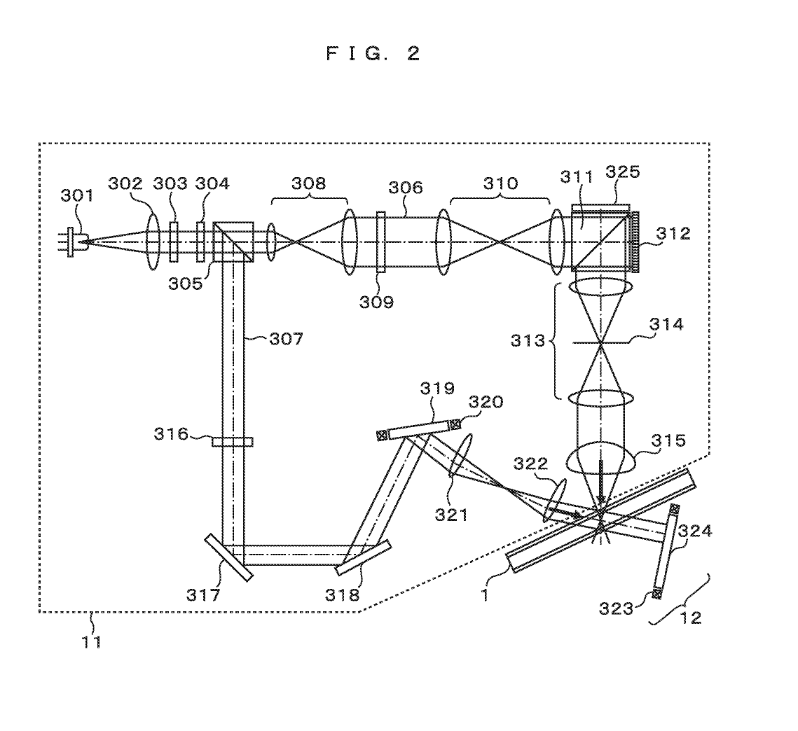

FIG. 2 shows an example of a basic optical system configuration of the pickup 11 in the hologram recording and reproducing apparatus 10. The light beam emitted from an external resonator type wavelength tunable laser 301 as an example of the light source enters a shutter 303. When the shutter 303 is opened, after the light beam has passed through the shutter 303, the light beam is controlled in a polarization direction by an optical element 304 configured by, for example, a half-wave plate or the like so that a light amount ratio of a p-polarized light and an s-polarized light reaches a desired ratio, and then enters a PBS (polarization beam splitter) prism 305.

The PBS prism 305 acts as a branch unit for branching the light beam emitted from the light source into the signal light and the reference light. As a signal light 306, the light beam that has transmitted through the PBS prism 305 is expanded by a beam expander 308, and then passes through a phase mask 309, a relay lens 310, and a PBS prism 311, and is incident on a spatial light modulator 312.

The signal light to which information is added by the spatial light modulator 312 is reflected by the PBS prism 311 and propagates through a relay lens 313 and a spatial filter 314. Thereafter, the signal light is focused on the hologram medium 1 by an objective lens 315.

On the other hand, the light beam that has been reflected by the PBS prism 305 acts as a reference light 307, and is set to a predetermined polarization direction according to the recording or reproduction by a polarization direction changing element 316. Thereafter, the light beam passes through a mirror 317 and a mirror 318, and enters a Galvano mirror 319. Because the Galvano mirror 319 can adjust the angle of the Galvano mirror 319 by an actuator 320, the Galvano mirror 319 can set an incident angle of the reference light incident on the hologram medium 1 after has passed through the lens 321 and the lens 322 to a desired angle.

In this way, the signal light and the reference light are made incident on the hologram medium 1 so as to overlap with each other, as a result of which an interference fringe pattern is formed in the hologram medium, and the pattern is written into the hologram medium to record the information. In addition, since the incident angle of the reference light incident on the hologram medium 1 can be changed by the Galvano mirror 319, angle multiplexing recording can be performed.

In the case of reproducing the recorded information, the reference beam is made incident on the hologram medium 1, and the light beam transmitted through the hologram medium 1 is reflected by the Galvano mirror 324 whose angle can be adjusted by the actuator 323, to thereby generate the reproduction reference light. The reproduced light reproduced by the reproduction reference light propagates through the objective lens 315, the relay lens 313, and the spatial filter 314. Thereafter, the reproduced light passes through the PBS prism 311 and is incident on the photodetector 325, thereby being capable of reproducing the recorded signal. As the photodetector 325, for example, an imaging element such as a CMOS image sensor or a CCD image sensor can be used.

Hereinafter, in the hologram recorded with a change in the reference light angle, the hologram corresponding to each reference light angle is called a page, and an aggregation of the pages multiplexed with a series of the reference light angles is called a book. Also, a unit in which the same book area is divided into a plurality of recording positions and recording is performed by changing the reference light angle at the same position in each recording position is called a stack. Therefore, one book is divided into stacks including a plurality of page groups, and the recording position is displaced for each stack and recorded.

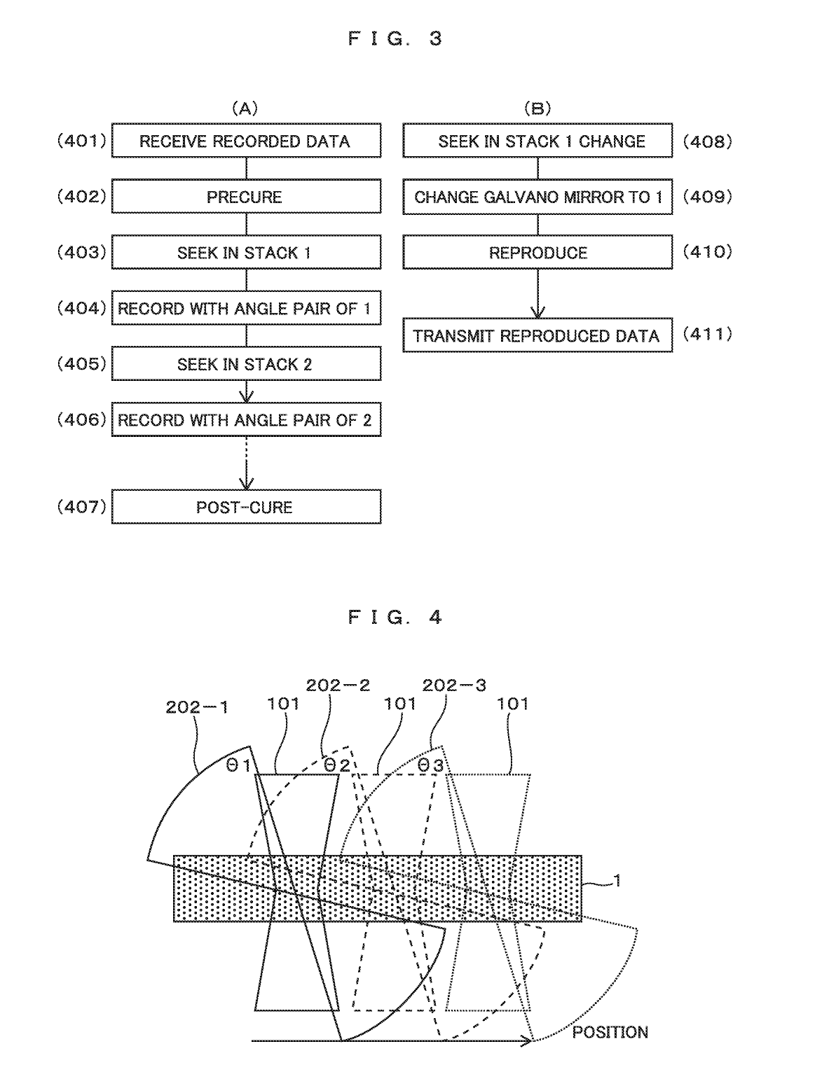

FIG. 3 show flows of the operation of recording and reproducing in the hologram recording and reproducing apparatus according to the present embodiment.

FIG. 3(A) shows an operation flow for recording the information on the hologram medium 1, and FIG. 3(B) shows an operation flow for reproducing the information recorded on the hologram medium 1.

First, as shown in FIG. 3(A), the recording operation flow first receives data to be recorded (401) and transmits information corresponding to the received data to the spatial light modulator 312 in the pickup 11. Thereafter, in order to record high-quality information on the hologram medium, the flow performs various recording learning processes such as optimization of a power of the external resonator type wavelength tunable laser 301 and optimization of an exposure time by the shutter 303 in advance. Thereafter, in the seeking operation, the flow controls the access control circuit 81 to position the pickup 11 and the curing optical system 13 at predetermined places of the hologram medium. Thereafter, the flow precures a predetermined area with the use of the light beam emitted from the curing optical system 13 (402), and performs the seeking operation for positioning the reference light and the signal light emitted from the pickup 11 at the places of a stack 1 (403). Then, the flow changes the reference light angle while swinging the Galvano mirror with an angle set of the reference light of θ1 allocated to the stack 1, and records a plurality of pages allocated to the stack 1 (404). When the page recording of the stack 1 is completed, the flow performs the seeking operation for positioning to a recording place of a next stack 2 (405). Then, the flow changes the reference light angle while swinging the Galvano mirror with an angle set of the reference light of θ2 allocated to the stack 2, and records a plurality of pages allocated to the stack 2 (406). Thereafter, when the same processing is repeated, and all of the stacks in the book are completely recorded, the postcuring is performed with the use of the light beam emitted from the curing optical system 13 (407).

Next, the operation flow of reproducing the recorded information, as shown in FIG. 3(B), first in the seeking operation, controls the access control circuit 81, and positions the pickup 11 and the reproduction reference light optical system 12 at places of the stack 1 of the hologram medium (408). Thereafter, the flow changes the reference light angle while swinging the Galvano mirror with the angle set of the reference light of θ1 allocated to the stack 1 (409), emits the reference light from the pickup 11, reproduces information recorded on a plurality of pages allocated to the stack 1 (410), and transmits the reproduced data (411). This shows data reproduction for one stack. If data for one book is to be reproduced, the seeking (408), the Galvano mirror change (409), and reproduction (410) described above are repeated for all of the stacks in the book.

Now, a relationship between the stack and each page as a premise of the present embodiment will be described. FIG. 13 is a conceptual diagram illustrating a state of recording for each stack. In FIG. 13, 1 denotes the hologram medium, 101 denotes a signal light, 102 denotes a reference light, and 102-1, 102-2, and 102-3 schematically show angle sets of the reference light of each stack. In other words, the angle multiplexing recording is performed with the angle sets θ1, θ2, and θ3 of the respective reference lights 102-1, 102-2, and 102-3, and the recording position relative to the signal light is displaced and recorded for each stack. A relationship of the angle sets of the reference lights at that time satisfies θ1<θ2<θ3. For example, in the case of 102-1, the angle set of θ1=13°, 14°, and 15° is assumed. In the case of 102-2, the angle set of θ2=16°, 17°, and 18° is assumed. In the case of 102-3, the angle set of θ3=19°, 20°, and 21° is assumed (actually the angle multiplexing number also becomes larger at finer angles).

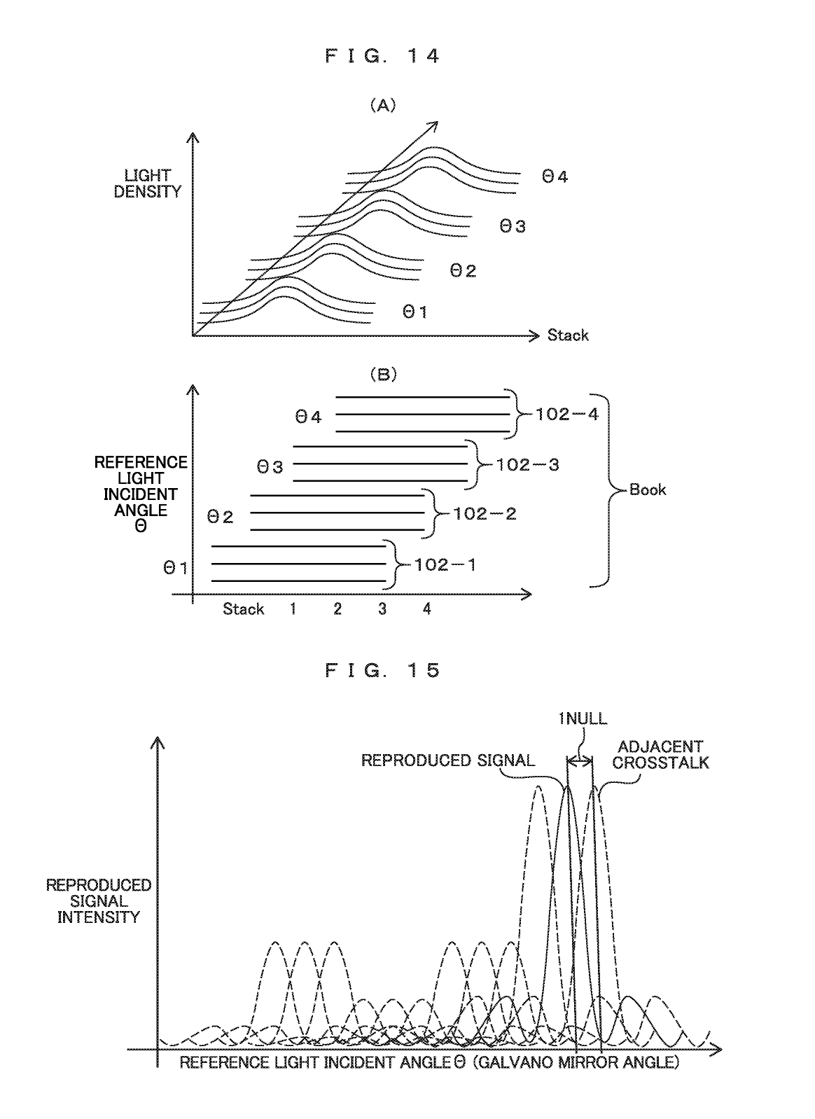

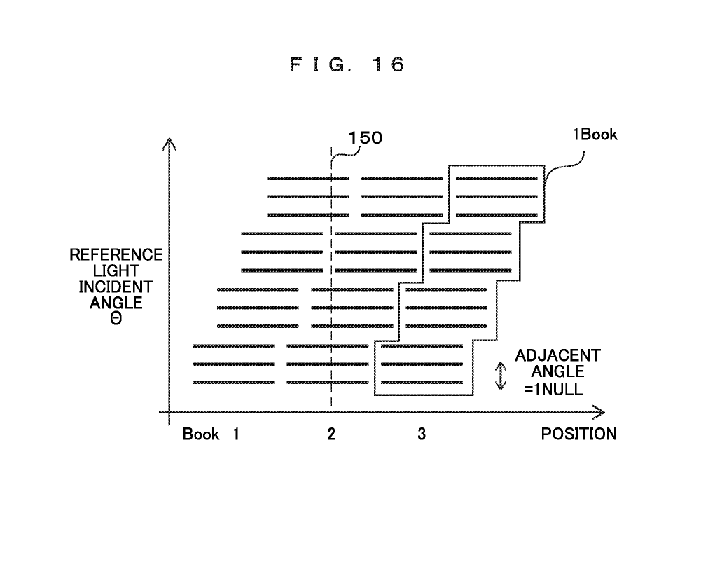

FIG. 14 are conceptual diagrams showing a relationship between the position of the stack and the reference light angle and light density. FIG. 14 illustrate a case where three pages are recorded per stack and one book is configured by four stacks. In FIG. 14(B), the stack 1 records three pages with the angle set of the reference light angle set θ1, and the stack 2 records three pages with the angle set of the reference light angle set θ2 with the displacement of the stack position. Further, FIG. 14(A) is a conceptual diagram of an optical density of each page configuring each stack. When the optical density of the signal light to be irradiated is high in the center and the reference light angle is continuously recorded on the same stack, an adjacent page and a high optical density portion come into contact with each other. In the case of the hologram, because the information to be recorded concentrates on a portion having the high light density and recorded, the recorded information comes into contact with each other and interferes with each other. FIG. 15 shows the reproduced signal intensity relative to the reference light incidence angle. In FIG. 15, the reference light incidence angle at which the reproduced signal intensity changes to the minimum from the maximum is defined as 1 NULL, and an interval between each adjacent page to be recorded is defined as 1 NULL. FIG. 16 is a conceptual diagram showing a relationship between the positions of the stack and the book and the reference light angle. FIG. 16 is a conceptual diagram in the case of recording three books each including four stacks shown in FIG. 14, and a portion surrounded by a square is one book. FIG. 15 shows the reproduced signal intensity when the reference light angle is changed along a dotted line 150 in FIG. 16 and reproduced. The reproduced signal intensity is large on the same stack, and becomes smaller as the position of the stack is away. Therefore, at the time of reproduction, the influence of crosstalk of adjacent pages which are the same stack appears greatly. Therefore, as can be seen from FIGS. 14, 15 and 16, it is understood that the interval between each adjacent page in the stack is 1 NULL, which is narrow. For that reason, there is a high possibility that the crosstalk occurs at the time of recording or reproducing with an adjacent page, and the recording quality and reproducing quality are deteriorated, which is a problem in high density recording.

The present embodiment provides a hologram recording and reproducing apparatus, and a hologram recording and reproducing method which are capable of solving the above problems and improving the recording quality with reduced crosstalk from the adjacent pages. Hereinafter, how to allocate the angles in the stack according to the present embodiment will be described.

FIG. 4 is a conceptual diagram illustrating a state of recording for each stack in the present embodiment. In FIG. 4, 1 denotes a hologram medium, 101 denotes a signal light, 202 denotes a reference light, and 202-1, 202-2 and 202-3 schematically denote angle sets of the reference light in each stack. In other words, angle multiplexing recording is performed at angle sets θ1, θ2, and θ3 of the respective reference lights 202-1, 202-2, and 202-3, and the recording position relative to the signal light is displaced and recorded for each stack.

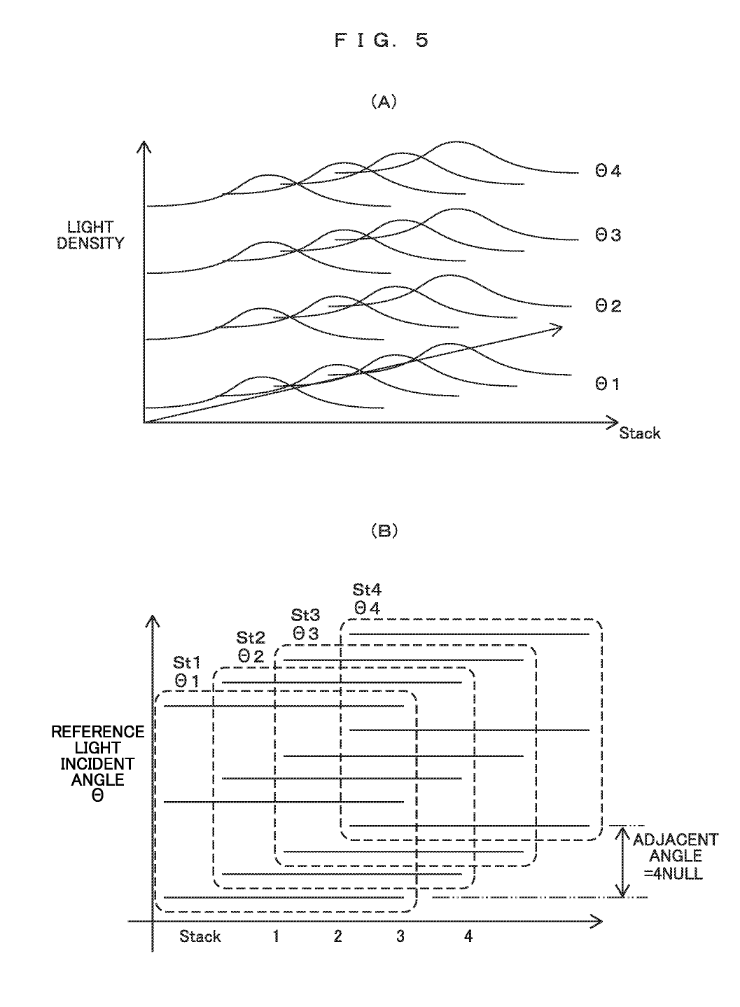

FIG. 5 are conceptual diagrams showing relationships between the position of each stack, the reference light angle, and the light density. FIG. 5 show a case where three pages are recorded per stack and one book is configured by four stacks. In FIG. 5(B), a stack 1 (St1) records three pages with the angle set of the reference light angle set θ1, but an reference angular interval between the respective pages is set to four times the minimum interval 1 NULL. Likewise, a stack 2 (St2) records three pages with the reference angular interval between the respective pages being 4 NULL at an angle displaced by 1 NULL from the reference light angle set θ1 of the stack 1. In other words, a reference light angle of another stack is allocated and recorded during the reference light angle of one stack. Hereafter, the same is applied to the stacks 3 and 4. FIG. 5(A) shows a conceptual diagram of optical density of each page configuring each stack. As can be seen from FIG. 5(A), it is found that 4 NULL is provided between the adjacent pages of each stack, and that the distance between the adjacent pages is enlarged.

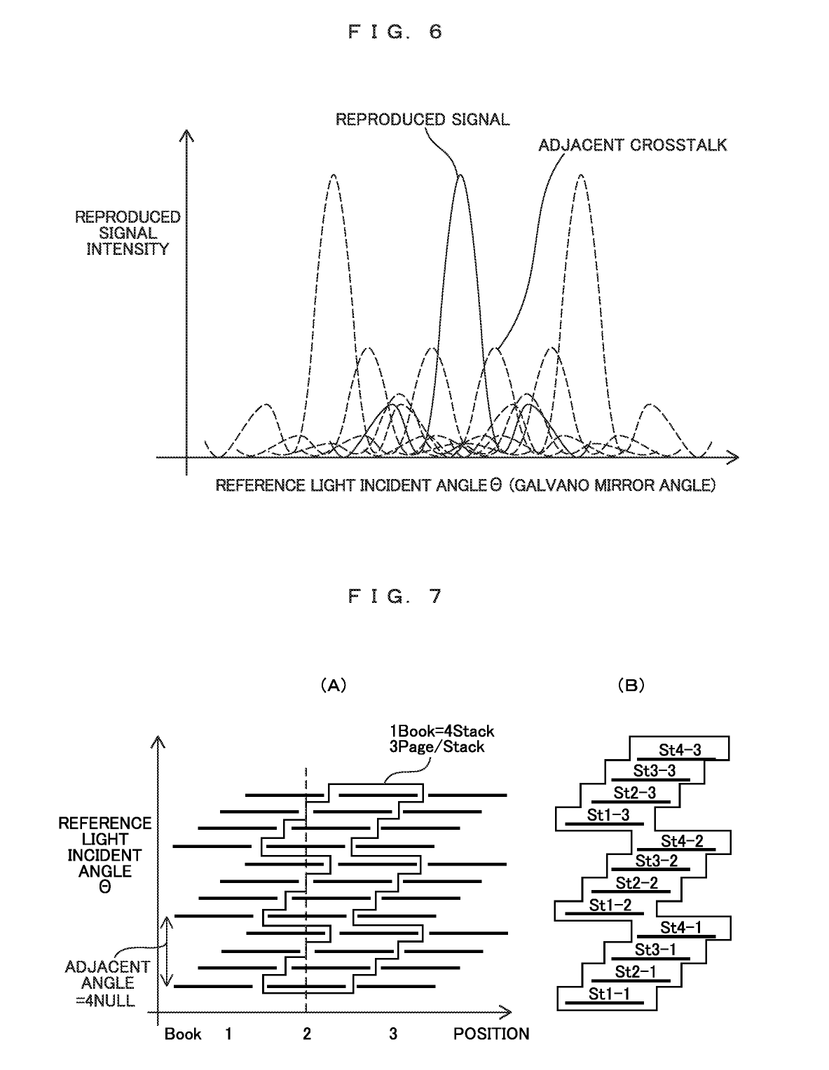

Also, the reproduced signal intensity relative to the reference light incidence angle is shown in FIG. 6. In FIG. 6, since the adjacent crosstalk for the maximum value of the reproduced signal intensity is 4 NULL apart, the influence becomes small.

FIG. 7 are conceptual diagrams showing relationships between the positions of the stack and the block and the reference light angle. FIG. 7(A) is a conceptual diagram in which three books each including four stacks are arranged as shown in FIG. 5, and a portion surrounded by a square is one book. Further, FIG. 7(B) is a diagram of one block extracted from FIG. 7(A), showing the relationship between the page and the stack. For example, St 1-1 means a first page of the stack 1. Therefore, as can be seen from FIG. 5, FIG. 6, and FIG. 7, in the present embodiment, the interval between each adjacent page in the stack is 4 NULL and the interval is enlarged. Therefore, the influence of inter-page crosstalk (interference) can be reduced.

As described above, in the present embodiment, in the adjacent stacks, the reference light angle of another stack is allocated and recorded in the reference light angle of one stack. In other words, recording by the adjacent reference light angles is performed at a position separated by one stack or more. As a result, the influence of inter-page crosstalk can be reduced.

Assuming that, for example, the number of stacks is 4 and the total number of pages per book is 500 in the allocation of the angles in the stack for the reference light angle set of each stack, the set of reference light angles allocated to each stack is expressed by the following formulas (1) to (4).

Stack 1: θ1=θ(1),θ(5) . . . θ(1+4k) . . . θ(497) (1)

Stack 2: θ2=θ(2),θ(6) . . . θ(2+4k) . . . θ(498) (2)

Stack 3: θ3=θ(3),θ(7) . . . θ(3+4k) . . . θ(499) (3)

Stack 4: θ4=θ(4),θ(8) . . . θ(4+4k) . . . θ(500) (4)

where θ(n) is the reference light angle, θ(n)<θ(n+1), n=1 to 500, and K=1 to 124.

In this way, in the present embodiment, an intersymbol interference can be reduced by selecting the reference light angle from the total angle width allocated to the book in each stack. Also, the reference light angle and the inter-stack distance can be determined so that the intersymbol interference is reduced.

In the present embodiment, the number of pages per stack and the number of stacks per book are not limited to the values described above. Also, the number of pages per stack need not be the same.

As described above, according to the present embodiment, there is provided a hologram recording and reproducing method in which an interference fringe pattern is formed with irradiation of a signal light and a reference light and written on a hologram medium to record information, and the interference fringe pattern is irradiated with the reference pattern to reproduce the recorded information, in which in the case where angle multiplexing recording is performed on a hologram medium page by page with a change in an incident angle of the reference light, when an angle multiplexing recording unit at the same location on the hologram medium is defined as a stack and an aggregation of a plurality of the stacks whose recording positions are displaced from each other is defined as a book, a reference light angle of another stack is allocated into a reference light angle of one stack for recording in the stacks adjacent to each other.

In addition, recording by the adjacent reference light angles is performed at a position separated by one stack or more.

Further, in each stack, the reference light angle is selected and set from the total angular width of the reference light allocated to the block.

Further, there is provided a hologram recording and reproducing apparatus in which an interference fringe pattern is formed with irradiation of a signal light and a reference light and written on a hologram medium to record information, and the interference fringe pattern is irradiated with the reference pattern to reproduce the recorded information, the hologram recording and reproducing apparatus including: a pickup that includes a light source which emits a light beam, a branch unit that branches the light beam emitted from the light source into the signal light and the reference light, a spatial light modulator for adding two-dimensional data to the signal light, and a Galvano mirror for changing an incident angle of the reference light; an access control circuit that performs seeking operation for positioning the reference light and the signal light emitted from the pickup at a predetermined place of the hologram medium; and a servo control circuit that controls operation of the pickup, in which in the case where angle multiplexing recording is performed on a hologram medium page by page with a change in an incident angle of the reference light, when an angle multiplexing recording unit at the same location on the hologram medium is defined as a stack and an aggregation of a plurality of the stacks whose recording positions are displaced from each other is defined as a book, a reference light angle of another stack is allocated into a reference light angle of one stack for recording in the stacks adjacent to each other, and the access control circuit performs the seeking operation for positioning the reference light and the signal light at a first stack place of the hologram medium, the servo control circuit swings the Galvano mirror with the reference light angle set allocated to the first stack to change the reference light angle, and records a plurality of pages allocated to the first stack, and when the page recording of the first stack is completed, the access control circuit performs the seeking operation for positioning at a recording place of a next second stack.

Therefore, according to the present embodiment, there can be provided the optical information recording and reproducing apparatus and the hologram recording and reproducing method which are capable of realizing recording quality with reduced crosstalk from adjacent pages, and capable of recording at a high density.

### Second Embodiment

In the present embodiment, a hologram recording and reproducing apparatus and a hologram recording and reproducing method which devise an angle allocation method in each stack in an angle set of a reference light of the stack and are capable of reducing influence of inter-page crosstalk will be described.

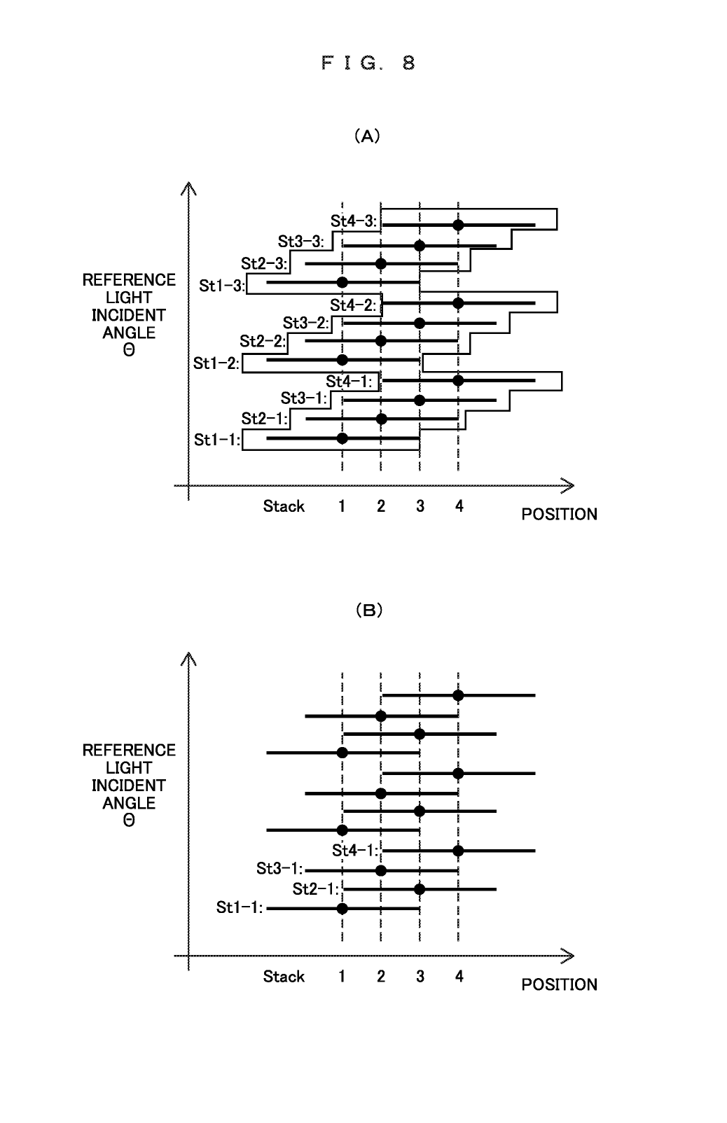

FIG. 8(A) is a conceptual diagram showing a relationship between a position of each stack and a reference light angle with an extraction of one book of FIG. 7 in the first embodiment. In other words, a case where three pages are recorded per stack and one book is configured by four stacks is illustrated. In FIG. 8(A), since a recording center position of each page has the highest light density, central portions of the respective pages are indicated by black dots. In FIG. 8(A), for example, an interval between recording positions of one page (St1-1) of a stack 1 and one page (St2-1) of a stack 2 is one stack. Similarly, an interval between one page of the stack 2 and one page of a stack 3, and an interval between one page of the stack 3 and one page of a stack 4 are one stack.

On the other hand, in the present embodiment, as shown in FIG. 8(B), the recording positions of one page (St2-1) of the stack 2 and one page (St3-1) of the stack 3 are replaced with each other. As a result, in FIG. 8(B), an interval between the recording positions of one page (St1-1) of the stack 1 and one page (St2-1) of the stack 2 is two stacks. Also, an interval between the recording positions of one page of the stack 3 and one page of the stack 4 is two stacks. Therefore, in the case of the present embodiment shown in FIG. 8(B), as compared with the case of the first embodiment shown in FIG. 8(A), the influence of inter-page crosstalk can be further reduced by separation of the recording positions.

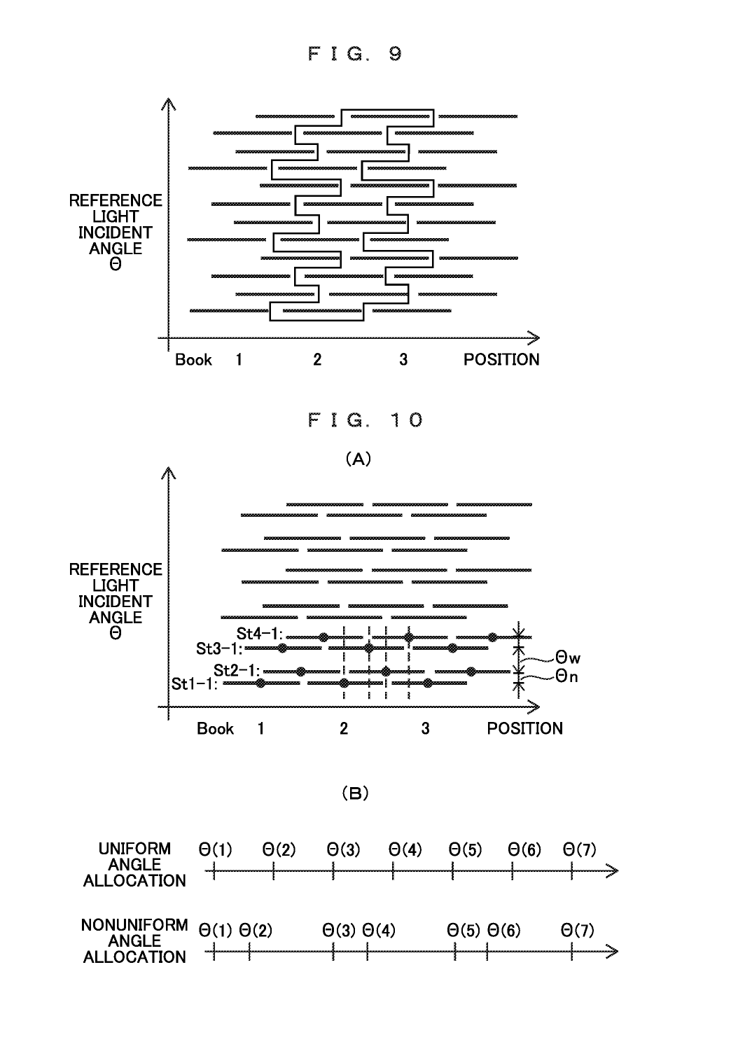

FIG. 9 shows a conceptual diagram showing as relationship between the positions of the stack and the book and the reference light angle in the present embodiment. FIG. 9 is a conceptual diagram in which three books each including four stacks shown in FIG. 8(B) are arranged, and a portion surrounded by a square is one book. In this way, the influence of inter-page crosstalk can be further reduced by determining the allocation of angles in the stack so that the reference light angles of adjacent stacks are not continuous but nested.

Regarding the angle set of the reference light of each stack in the present embodiment, in the method of allocating the angles in the stack, when it is assumed that, for example, the number of stacks is 4 and the total number of pages per book is 500, the set of reference light angles to be allocated to each stack is expressed by the following formulas (5) to (8).

Stack 1: θ1=θ(1),θ(5) . . . θ(1+4k) . . . θ(497) (5)

Stack 2: θ3=θ(3),θ(7) . . . θ(3+4k) . . . θ(499) (6)

Stack 3: θ2=θ(2),θ(6) . . . θ(2+4k) . . . θ(498) (7)

Stack 4: θ4=θ(4),θ(8) . . . θ(4+4k) . . . θ(500) (8)

where θ(n) is the reference light angle, θ(n)<θ(n+1), n=1 to 500, and K=1 to 124.

### Third Embodiment

In the present embodiment, a hologram recording and reproducing apparatus and a hologram recording and reproducing method which devise an angle allocation method in each stack in an angle set of a reference light of the stack and are capable of reducing influence of inter-page crosstalk will be described. In other words, an embodiment that pays attention to an interval of reference light angles will be described.

FIG. 10 are conceptual diagrams showing relationships between positions of stacks and books and reference light angles in a case where allocation of the reference light angles is not uniformly but nonuniformly performed on the assumption that angles are allocated in the stack so that the reference light angles of the adjacent stacks in FIG. 9 of the second embodiment are not consecutive but nested. In other words, in FIG. 10(A), an interval between reference light angles of one page (St1-1) of a stack 1 and one page (St2-1) of a stack 2 is narrowed (θn), and an interval between reference light angles of one page (St2-1) of the stack 2 and one page (St3-1) of a stack 3 is widened (θw). The reason is that since the interval between recording positions of one page (St1-1) of the stack 1 and one page (St2-1) of the stack 2 is as wide as two stacks, there is a margin for the influence of the inter-page crosstalk, and therefore the interval between the reference light angles is narrowed. In addition, since the interval between the recording positions of one page (St2-1) of the stack 2 and one page (St3-1) of the stack 3 is as narrow as one stack, the influence of inter-page crosstalk is severe, and therefore the intervals of the reference light angles are widened.

As a result, there is a feature that the quality is stabilized as a whole. FIG. 10(B) shows a relationship of the reference light angles between a uniform angle allocation and a nonuniform angle allocation.

As described above, in the present embodiment, when the recording position intervals to the adjacent pages are different from each other, in the case of a close position susceptible to the inter-page crosstalk, the interval between the reference light angles is widened. In the case of a distant position that is not easily influenced by the inter-page crosstalk, the interval between the reference light angles is narrowed, thereby being capable of reducing the influence of the overall inter-page crosstalk.

### Fourth Embodiment

In the present embodiment, a hologram recording and reproducing apparatus and a hologram recording and reproducing method which devise the arrangement of stacks in recording positions of respective stacks and are capable of reducing influence of inter-page crosstalk will be described. In other words, an embodiment that pays attention to the stack recording positions will be described.

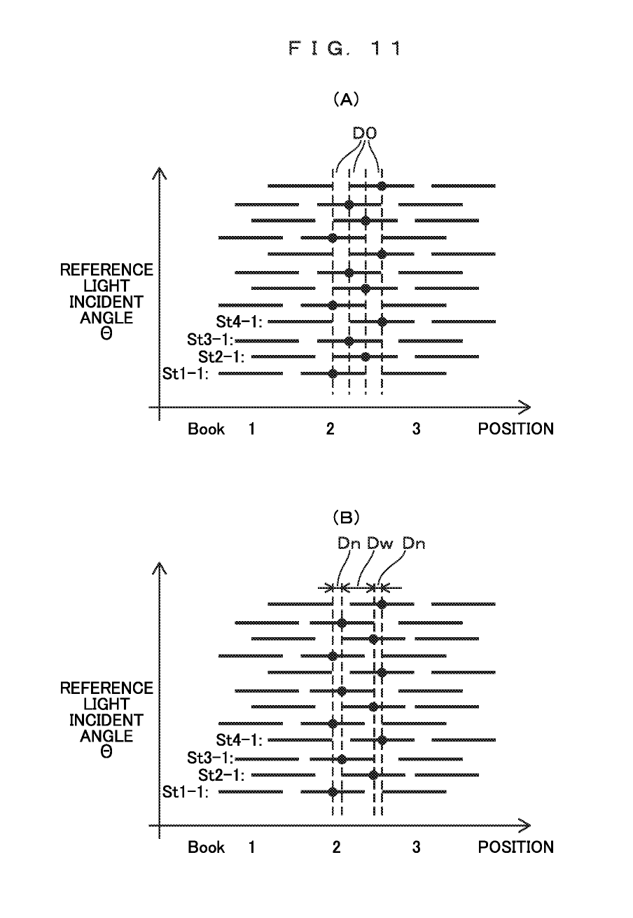

FIG. 11 are conceptual diagrams showing relationships between positions of stacks and books and reference light angles in a case where stack recording positions are made uniformly or nonuniform on the assumption that angles are allocated in the stack so that the reference light angles of the adjacent stacks in FIG. 9 of the second embodiment are not consecutive but nested. In other words, in FIG. 11(A), as shown in FIG. 9 of the second embodiment, intervals between the stack recording positions are equal to D0 as indicated by dotted lines. However, the interval between the reference light angles of one page (St1-1) of a stack 1 and one page (St3-1) of a stack 3 is as wide as 2 NULL, and the interval between the reference light angles of one page (St2-1) of the stack 2 and one page (St3-1) of a stack 3 is as narrow as 1 NULL.

Therefore, in the present embodiment, as shown in FIG. 11(B), in order to reduce the influence of interference between the pages of the stack 2 and the stack 3 in which the interval of the reference light angles is narrow, the recording position interval between the stack 2 and the stack 3 is widened (Dw). Also, the stacks 1 and 3 in which the interval between the reference light angles is wide have a margin against the influence of interference between the pages, and therefore the recording position interval between the stack 1 and the stack 3 is narrowed (Dn). Similarly, since an interval between the reference light angles of one page (St2-1) of the stack 2 and one page (St4-1) of a stack 4 is as wide as 2 NULL, there is a margin for the influence of interference between the pages, and therefore the recording position interval between the stack 2 and the stack 4 is narrowed (Dn).

As described above, when the intervals between the reference light angles to the adjacent pages are different from each other, if the interval between the reference light angles, which is susceptible to the inter-page crosstalk, is narrow, the recording position interval of the stacks is widened. If the interval between the reference light angles, which is not easily influenced by the inter-page crosstalk, is wide, the recording position interval of the stacks is narrowed, thereby being capable of reducing the influence of the overall inter-page crosstalk.

### Fifth Embodiment

In the present embodiment, an example in which angle sets of reference lights of different stacks in different books are used will be described.

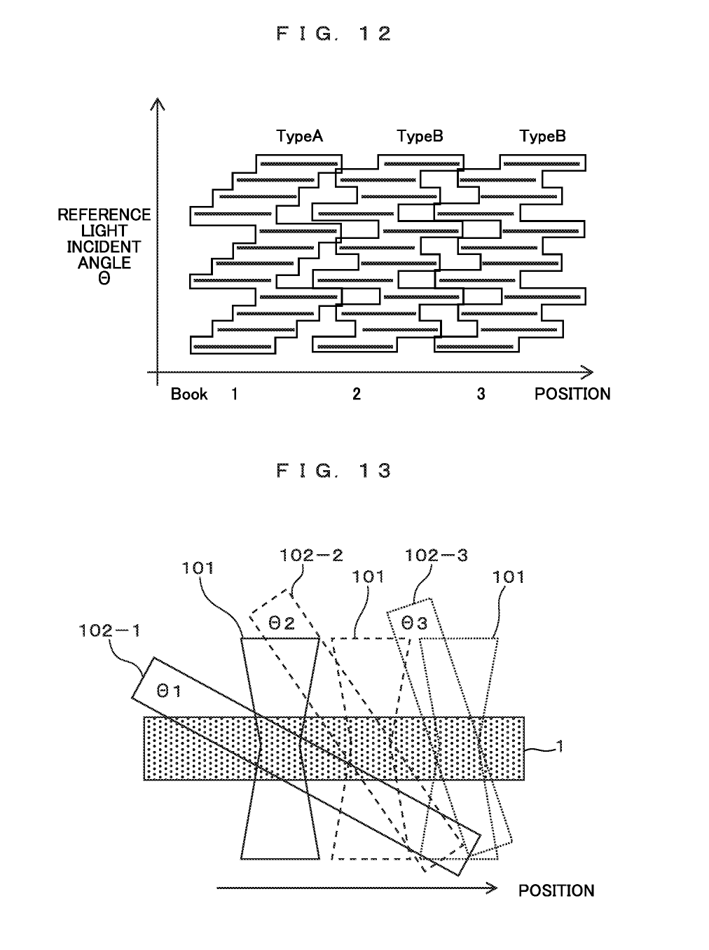

FIG. 12 is a conceptual diagram showing a relationship between positions of stacks and books and reference light angles in the case of recording three books each including four stacks with three-page recording per stack. In FIG. 12, a portion surrounded by a square is one book, a type A is a book using an angle set of the reference light of the stack in the first embodiment, and a type B is a book using an angle set of reference light of the stack in the second embodiment.

In this manner, with the use of the angle sets of the reference lights of a plurality of stacks in different books, a recording method can be selected according to the type of information to be recorded. For example, control information such as logical information of a disc, recorded information, information for compatibility between devices, which is information necessary for control, is high in access frequency and requires reliability such as device compatibility. Therefore, the angle sets of the reference light of the stack in which the reference light angles of the adjacent stacks in the first embodiment are continuously changed are used as a standard format having no device dependency which is as simple as possible. Further, a method of recording data peculiar to the hologram recording and reproducing apparatus, for example, an apparatus-dependent recording method, uses, as a special format, the angle set of the reference lights of the stack in which the reference light angles of the adjacent stacks are not continuous but nested as in the second embodiment for example, in which the influence of the inter-page crosstalk is further reduced and high density recording is possible. The angle set of the reference lights of the stack in the second embodiment may be replaced with the angle set of the reference light of the stack in the third or fourth embodiment.

It should be noted that the control information emphasizes the recording quality, the normal data emphasizes high density recording, and the angle stacks of the reference lights of different stacks in different blocks may be used.

The respective embodiments of the present invention have been described above. However, the present invention includes various modifications without departing from the subject matter of the present invention. In the abovementioned embodiments, in order to easily understand the present invention, the specific configurations are described. However, the present invention does not always provide all of the configurations described above. Also, a part of the configuration of an embodiment can be replaced with the configuration of another embodiment, and the configuration of one embodiment can be added with the configuration of another embodiment. Also, in a part of the configuration of the respective embodiments, another configuration can be added, deleted, or replaced.

### LIST OF REFERENCE SIGNS

1, hologram medium; 10, hologram recording and reproducing apparatus; 11, pickup; 12, reproduction reference light optical system; 13, curing optical system; 14, optical system for detecting a disc rotation angle; 81, access control circuit; 82, a light source driving circuit; 83, servo signal generation circuit; 84, servo control circuit; 85, signal processing circuit; 86, generation circuit; 87, shutter control circuit; 88, disc rotation motor control circuit; 89, controller; 90, input/output control circuit; 91, external control device; 301, external resonator type wavelength tunable laser; 303, shutter; 305, PBS prism; 306, signal light; 307, reference light; 308, beam expander; 309, phase mask; 310 and 313, relay lens; 311, PBS prism; 312, spatial light modulator; 314 spatial filter; 315, objective lens; 316, polarization direction conversion element; 319 and 324, Galvano mirrors; 320 and 323, actuators; 321 and 322, lenses; 325, photo detector; 101, signal light; 102-1, 102-2, 102-3, 202-1, 202-2, and 202-3, reference lights; and θ1, θ2, θ3, and θ4, angle pairs of reference light of each stack

1. A hologram recording and reproducing method in which an interference fringe pattern is formed with irradiation of a signal light and a reference light and written on a hologram medium to record information, and the interference fringe pattern is irradiated with the reference pattern to reproduce the recorded information,
wherein in the case where angle multiplexing recording is performed on a hologram medium page by page with a change in an incident angle of the reference light, when an angle multiplexing recording unit at the same location on the hologram medium is defined as a stack and an aggregation of a plurality of the stacks whose recording positions are displaced from each other is defined as a book, a reference light angle of another stack is allocated into a reference light angle of one stack for recording in the stacks adjacent to each other.

2. The hologram recording and reproducing method according to claim 1,
wherein recording by the adjacent reference light angles is performed with a position separated by one stack or more.

3. The hologram recording and reproducing method according to claim 1,
wherein the reference light angle is selectively set from the total angular width of the reference light allocated to the book in each stack.

4. The hologram recording and reproducing method according to claim 1,
wherein the reference light angle of the one stack is continuously allocated.

5. The hologram recording and reproducing method according to claim 1,
wherein the reference light angles of the respective stacks are allocated in a nested relationship.

6. The hologram recording and reproducing method according to claim 5,
wherein the reference beam angles of the stacks are nonuniformly allocated.

7. The hologram recording and reproducing method according to claim 6,
wherein when a recording position interval to an adjacent page is different from each other, an allocation interval of the reference light angle of the stack is changed according to the recording position interval.

8. The hologram recording and reproducing method according to claim 5,
wherein the recording position intervals of the stacks are set to be nonuniform.

9. The hologram recording and reproducing method according to claim 8,
wherein when the interval of the reference light angle to the adjacent page is different, the recording position interval of the stack is changed according to the interval.

10. The hologram recording and reproducing method according to claim 1,
wherein the reference light angle set of a plurality of stacks which are allocated different in stack light reference angles is used among the books.

11. A hologram recording and reproducing apparatus in which an interference fringe pattern is formed with irradiation of a signal light and a reference light and written on a hologram medium to record information, and the interference fringe pattern is irradiated with the reference pattern to reproduce the recorded information, the hologram recording and reproducing apparatus comprising:
a pickup that includes a light source which emits a light beam, a branch unit that branches the light beam emitted from the light source into the signal light and the reference light, a spatial light modulator for adding two-dimensional data to the signal light, and a Galvano mirror for changing an incident angle of the reference light;
an access control circuit that performs seeking operation for positioning the reference light and the signal light emitted from the pickup at a predetermined place of the hologram medium; and
a servo control circuit that controls operation of the pickup,
wherein in the case where angle multiplexing recording is performed on a hologram medium page by page with a change in an incident angle of the reference light, when an angle multiplexing recording unit at the same location on the hologram medium is defined as a stack and an aggregation of a plurality of the stacks whose recording positions are displaced from each other is defined as a book, a reference light angle of another stack is allocated into a reference light angle of one stack for recording in the stacks adjacent to each other, and the access control circuit performs the seeking operation for positioning the reference light and the signal light at a first stack place of the hologram medium,
the servo control circuit swings the Galvano mirror with the reference light angle set allocated to the first stack to change the reference light angle, and records a plurality of pages allocated to the first stack, and
when the page recording of the first stack is completed, the access control circuit performs the seeking operation for positioning at a recording place of a next second stack.
